(19) United States
(12) Patent Application Publication
(10) Pub. No.: US 2008/0216078 A1
(43) Pub. Date: Sep. 4, 2008

(54) Request scheduling method, request scheduling apparatus, and request scheduling program in hierarchical storage management system

(75) Inventors: Hiroyuki Miura, Kawasaki (JP); Satoshi Taki, Kawasaki (JP); Ken Oshita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/073,040

(22) Filed: Feb. 28, 2008

(30) Foreign Application Priority Data
Mar. 2, 2007 (JP) 2007-53128

(51) Int. Cl. G06F 12/00; G06F 9/46

(52) U.S. Cl. 718/102; 711/E12.001

(57) ABSTRACT

A request scheduling for scheduling requests to a secondary recording media while minimizing the frequency of recording-medium mounting/removing events in a secondary storage unit of an HSM (hierarchical storage management) system by searching for one or more request(s) processed or to be executed as executable on a drive unit, in units of the drive unit. According to the searching, detecting one or more generated read request(s) to read data from a recording medium mounted on the drive unit, and setting the drive unit as an exclusive drive for the read request(s). And scheduling a drive unit having an elapsed time period for a mounted recording media not exceeding a predetermined time period to execute an executable request by priority.

### CROSS-REFERENCE TO RELATED APPLICATIONS

This application is related to and claims the benefit of priority from Japanese Patent Application No. 2007-053128, filed on Mar. 2, 2007, the entire contents of which are incorporated herein by reference.

### BACKGROUND

### Field

The embodiments relate to a technique for causing a computer to perform scheduling of a request(s) for a secondary storage unit in a hierarchical storage management system that includes a plurality of drive units and the hierarchical storage management system controls storage units automatically removably mountable on the respective drive units as the secondary storage unit.

Recently, digitization of information has advanced, and even information of the type having never been handled in systems is digitized. Thereby, the amount of data for storing is rapidly increased, and also the amount of maintenance costs associated with the increase in the amount of data is increased. Under these circumstances, hierarchical storage management (HSM) systems are recently utilized. An HSM system is known as a system capable of storing a large amount of data at low cost while maintaining the access speed.

The HSM system includes at least two storage devices different in access speed from each other, respectively, as primary and secondary storage units. In this system configuration, a file having a high access frequency (necessity) is automatically moved to the primary storage unit with high speed (access speed), and a file having a low access frequency is automatically moved to the secondary storage unit with low speed. Thereby, an environment is realized that virtualizes the overall system and, concurrently, that enables high speed access.

However, normally, a storage unit with high access speed is expensive, and a storage unit with low access speed is cheap or less-expensive. For this reason, by using the cheap storage unit with low access speed as the secondary storage unit, the cost of the overall system can be reduced, and concurrently, a large amount of data can be stored. Normally, the primary storage unit is configured from a disk array including a plurality of disk drives (drive units each for driving a built-in disk), such as hard disk drives. The secondary storage unit, normally, is configured from DVDs (digital versatile discs), a drive unit including a replaceable recording medium such as a magnetic tape, or a plurality of such drive units. Magnetic tapes draw attention to their advantages in cost and data preservation.

In the system, when access is made to data not existing in the primary storage unit, a request (read request) for reading the data is issued. In response to the read request, the data is read from the secondary storage and is transferred to the primary storage unit.

A required time period for each process is longer in the secondary storage unit than in the primary storage unit. In the event of the process of the read request, a recording medium containing recorded or written data has to be mounted on the drive unit. Mounting of the medium on the drive unit requires a relatively long time period, so that also a wait time period before data is read is increased thereby. In the event that such a drive unit is in use for a different process, the wait time period is further increased to the extent of adversely effecting operation by a user. In this view, there is a probability that an execution sequence (schedule) of execution of requests in the secondary storage unit imposes significant affects on the performance (access speed).

In addition to the read request mentioned above, requests to be issued for the secondary storage unit includes, but not limited to, a write request, a rebuild request, and a garbage collection request. The write request is issued for writing data onto the recording medium. The rebuild request is issued for rebuilding or recovering redundancy in the event of occurrence of failure in one of recording media constituting a logical volume by mirroring. The garbage collection request is issued for eliminating unnecessary areas, if any, in the recording medium. Priorities are preliminarily determined for the requests. Thus, according to a conventional request scheduling apparatus for performing request scheduling basically operates such that the requests are processed in order of high priorities of the requests(Japanese Laid-open Patent Publication No. S60-147855). For this reason, a problem arises in that there are likely to occur states in which recording-medium mounting/removing events frequently occur to the extent of degrading the performance.

FIG. 5 is a diagram showing a time variation in an occurrence rate of request issuance events in the HSM system. FIG. 5 shows a variation in an occurrence rate of requests to the primary and secondary storage units per day by use of arrows. In FIG. 5, the arrows indicate the direction of data transfer. For example, an arrow mark in the direction from the primary storage unit to the secondary storage unit indicates a write request for storing data in the primary storage unit into the secondary storage unit.

As described above, it takes a long time period for access to the secondary storage unit. Thus, normally, as shown in FIG. 5, such a request for access to the secondary storage unit is issued and processed in a time zone (night time) during which the frequency of access associated with jobs is reduced, and necessary data is stored in the primary storage unit by job starting time on the following date. Thereby, it is predicted that requests for the secondary storage unit are somewhat concentrated.

In the event that requests for the secondary storage unit are centralized, frequent recording-medium mounting/removing events can be a cause of a significant increase in an average required time period for the request process. Further, the frequent recording-medium mounting/removing events can be a cause of accelerating wear of the recording medium. As such events are taken into account, it is considered very important to draw attention on the frequency of recording-medium mounting/removing (replacement) events.

### SUMMARY

According to an aspect of an embodiment, a technique is provided for scheduling requests while minimizing the frequency of recording-medium mounting/removing events in a secondary storage unit of an HSM (hierarchical storage management) system.

In accordance with an aspect of an embodiment, a request scheduling method is provided for performing scheduling of a request(s) for a secondary storage unit in a hierarchical storage management system that includes a plurality of drive units and that controls a storage unit as the secondary storage unit, the storage unit permitting recording media to be removably mounted on the respective drive units, by performing referential access to a request(s) processed or executed on the drive unit, in units of the drive unit, and in accordance with a result of referential access to a read request(s) generated to read out data from the mounted recording medium, setting the drive unit as an exclusive drive for the read request(s), whereby the scheduling of the request(s) is performed.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a configuration diagram of an HSM (hierarchical storage management) system employing a request scheduling apparatus of an embodiment;

FIG. 2 is a diagram descriptive of request management information for managing request scheduling;

FIG. 3 is a diagram descriptive of read-wait mode setting for tape drives constituting a tape drive group;

FIGS. 4A-4B are flow charts representing a scheduling process, according to an embodiment; and

FIG. 5 is a diagram showing time variations in an occurrence rate of request issuance in the HSM system.

### DETAILED DESCRIPTION OF THE PREFERRED EMBODIMENTS

An embodiment will be described in detail with reference to the accompanying drawings.

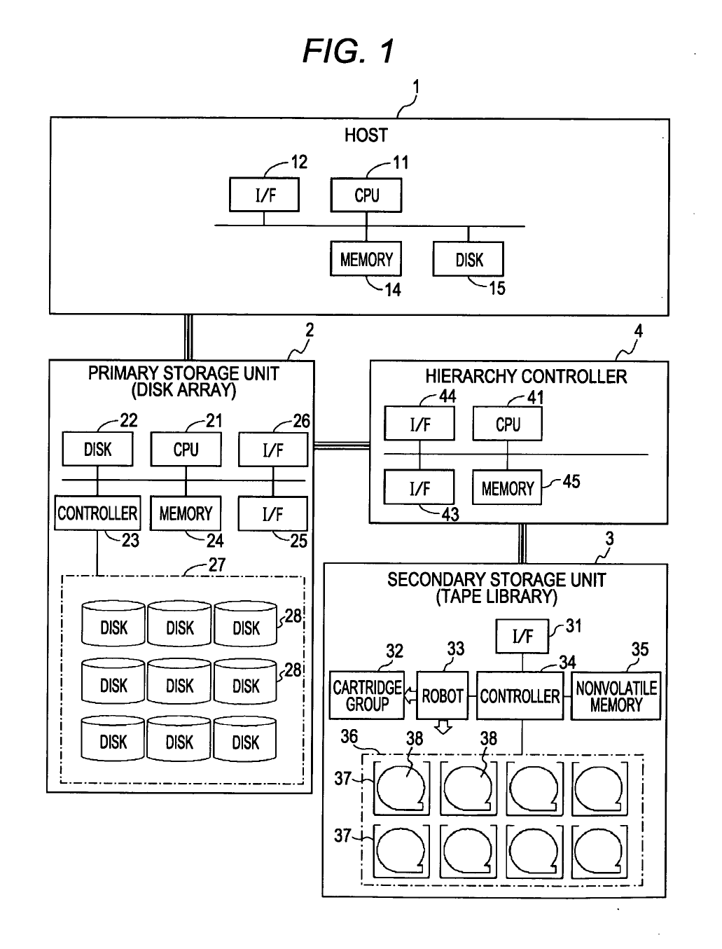

FIG. 1 is a configuration diagram of a hierarchical storage management (HSM) system employing a request scheduling apparatus according to an embodiment. The HSM system is configured by using a host computer 1 (“host”, hereinbelow) connected to a communications network, and includes a disk array assigned as a primary storage unit 2 and a tape library assigned as a secondary storage unit 3. The tape library includes a plurality of tape drives 37 respectively on which magnetic tapes 38 are removably mountable. The primary storage unit 2 provides to the host 1 a logical volume larger in storage capacity than the disk array of the system. A hierarchy controller 4 is provided between the primary and secondary storage units 2 and 3. In operative association with the primary storage unit 2, the hierarchy controller 4 automatically performs data movement between itself and the secondary storage unit 3, and is capable of performing inter-hierarchy data management. The primary and secondary storage units 2 and 3 are virtualized by the primary storage unit 2 and the hierarchy controller 4. The hierarchy controller 4 includes the request scheduling apparatus of the present embodiment for the secondary storage unit 3.

The host 1 is a computer including a CPU (central processing unit) 11, an interface (I/F) 12, a memory 14, and a disk device 15 respectively connected to a bus. The I/F 12 is used for connection to the primary storage unit 2. The disk device 15 contains programs that are executed by the CPU 11. Other components such as an I/F used for connection to the communications network are not shown.

The primary storage unit 2 includes a CPU 21, a disk device 22, a controller 23, a memory 24, and two I/F's 25 and 26 that are respectively connected to a bus. The primary storage unit 2 further includes a disk array 27 including a plurality of disk drives 28 and connected to the controller 23. The disk device 22 is used to store meta information. The memory 24 contains programs that are executed by the CPU 21, the programs including, for example, a data accessing program and a linkage program that is used to provide large logical volumes to the host 1 in operative association with the hierarchy controller 4. One of the two I/F's 25 and 26 is used for connection to the host 1, and the other one thereof is used for connection to the hierarchy controller 4. The controller 23 operates in response to a command received from the CPU 21. If any one of the disk drives 28 contains data, then the controller 23 accesses the disk drive 28 containing the data. If no one of the disk drives 28 contains the data, on the other hand, the controller 23 requests the hierarchy controller 4 for the data to acquire the data from the secondary storage unit 3.

The secondary storage unit 3 includes an I/F 31, a cartridge group 32, a robot 33, a controller 34, a nonvolatile memory 35, and a tape drive group 36 that includes the plurality of tape drives 37 respectively on which the magnetic tapes 38 can be removably mounted.

The I/F 31 is used for connection to the hierarchy controller 4. As the respective magnetic tape 38, a tape of a cartridge type is used for easy use. The cartridge group 32 is configured from the magnetic tapes 38 mountable on the respective tape drives 37. In practice, the cartridge group 32 corresponds to an accommodation portion capable of storing a plurality of magnetic tapes 38 and one or more magnetic tapes 38 stored in the accommodation portion. The robot 33 moves the magnetic tape 38 between the accommodation portion and the tape drive 37. The controller 34 controls the robot 33 to mount a necessary magnetic tape 38 on a corresponding tape drive 37, thereby to perform access to the magnetic tape 38. In order to perform the access, meta information about the magnetic tapes 38 are stored into the nonvolatile memory 35. The meta information to be stored include, for example, identification information (such as an identifier (ID)), amount of accumulated data, and storage file information of the respective magnetic tape 38. The magnetic tape 38 hereinbelow will be alternatively referred to a “cartridge”.

The hierarchy controller 4 is a computer including a CPU 41, two I/F's 43 and 44, and a memory 45 that are respectively connected to a bus. Programs to be executed by the CPU 41 are stored in the memory 45. The two I/F's 43 and 44, respectively, are used for connection to the primary and secondary storage units 2 and 3.

The hierarchy controller 4 contains a preliminarily installed hierarchy control program for the use of virtualization of the primary and secondary storage units 2 and 3 to thereby perform data management. In the host 1, the disk device 15 contains a preliminarily installed file system or a file managing program that operates to enable storing files into the logical volume formed from the primary and secondary storage units 2 and 3.

Access to the primary storage unit 2 of the host 1 is performed by the file system. Access information related to accessed data (file) is notified to the hierarchy control program by the linkage program. Being thus notified, the hierarchy control program recognizes, for example, the frequency of access to data stored in the primary storage unit 2. The amount of empty spaces available in the primary storage unit 2 is verified by, for example, making an inquiry to the primary storage unit 2. In this manner, the hierarchy control is performed corresponding to the state of access by the host 1 to the primary storage unit 2 and the amount of empty spaces available in the primary storage unit 2.

According to the hierarchy control, when the file system (host 1) attempts to access data not contained in the primary storage unit 2, the corresponding data is read out from the secondary storage unit 3 and then is transferred to the primary storage unit 2. When the amount of empty spaces in the primary storage unit 2 has become insufficient, data with less access frequency and old last access times are read out from the primary storage unit 2 and are stored into the secondary storage unit 3. Such an inter-hierarchy data movement is executed through communication of the data between the primary storage unit 2 and the hierarchy controller 4.

The secondary storage unit 3 is accessed by issuance of a request. The hierarchy control program references or performs referential accesses to meta information contained in the memory 45, thereby to issue the request in units of each cartridge 38. The issued request is executed in the manner that, for example, a command is generated from the request and is output to the secondary storage unit 3.

The command is processed by the controller 34 into which the command is input through the I/F 31. While referencing the meta information contained in the nonvolatile memory 35, the controller 34 performs control for a process specified from the hierarchy controller 4 in accordance with the command. The execution result of the process is notified to the hierarchy controller 4.

Requests for the secondary storage unit 3 include, but not limited to, a read request, a write request, a rebuild request, a garbage collection request, and a redundant copy request. The read request is issued for reading data. The write request is issued for writing data of the primary storage unit 2. The rebuild request is issued for rebuilding or recovering redundancy in the event of occurrence of failure in one of the cartridges 38 constituting a logical volume by mirroring. The garbage collection request is issued for eliminating unnecessary areas, if any, in the recording medium. The redundant copy request is issued to secure data integrity in the manner that data is copied from, for example, an old cartridge 38 or a cartridge 38 with a high error occurrence rate to another cartridge 38.

The write request refers to any of, for example, a write request that is automatically generated to increase the amount of empty spaces of the primary storage unit 2 when the amount of empty spaces is insufficient; a write request that is automatically generated when a predetermined time period is elapsed in the state when data written into the primary storage unit 2 is not written into the cartridge 38, and a write request that is generated in response to a specification received from a system administrator. The write requests, respectively, have predetermined priorities. For example, highest priority is given to the write request that is automatically generated to increase the amount of empty spaces of the primary storage unit 2.

The read request refers to any of, for example, a read request that is automatically generated when the host 1 attempts to access data contained in the secondary storage unit 3, and a read request that is generated in response to a specification received from the system administrator. For example, a higher priority is set to the former write request.

The respective cartridges 38 constituting the logical volume are configured in a redundant form by, for example, mirroring. When a fault, such as failure, has occurred with one cartridge 38, data is copied from the other cartridge 38 to an empty cartridge 38.

The garbage collection request is generated in response to an operation (specification) by the system administrator. The respective cartridge 38 is set for use in a write-once form type; that is, data once written into the cartridge 38 cannot be deleted or erased. Therefore, when same data (file) is written a couple of times thereinto, areas other than a lastly written area are unnecessary areas that are not referenceable from the user. The garbage collection request is issued to eliminate such an unnecessary area from a copy source cartridge 38 in the manner that an unnecessary area is remained and only data in a necessary area is copied to another empty cartridge 38. The redundant copy request is generated in response to a specification issued by the system administrator.

For the request generation by operation by the system administrator, two ways are available. One way is that conditions for request generation are specified by the system administrator, in which the request is automatically generated when the conditions are satisfied. The other way is that the request is directly generated by the system administrator by selecting a logical volume or cartridge 38. More specifically, it is assumed that a garbage collection request is generated according to the former manner in order to accomplish that “the garbage collection request is executed during a time period from 18:00 (in the afternoon) to 8:00 (in the following morning) for a cartridge 38 having an unnecessary area exceeding 50% of the overall area. In this case, the percentage of the unnecessary area with respect to the overall area, a time zone for request execution, and the like are specified as condition by the system administrator. In practice, the specifying operation is performed using either an input device connected to the hierarchy controller 4 or a terminal device connected to the hierarchy controller 4 via the communications network.

Automatic request generation is executed by necessity in response a notification output from the linkage program of the primary storage unit 2. In response to the notification received from the linkage program, either the read request for reading out necessary data from the secondary storage unit 3 or the write request for increasing the amount of empty spaces of the primary storage unit 2 is issued. In response to the notification from the controller 34, the write request associated with the elapse of the predetermined time period and the rebuild request are issued.

The write request and the read request are processed in units of a logical block length, and the other requests are processed in units of the cartridge 38. The priority (level) is set higher to requests having greater influences to the user's system usage. Basically, for example, the priorities are set in order from the high level, as follows:

Write requests from the primary storage unit 2 to the secondary storage unit 3 to allocate the empty area of the primary storage unit 2

Read requests generated by user access from the secondary storage unit 3 to the primary storage unit 2

Other requests

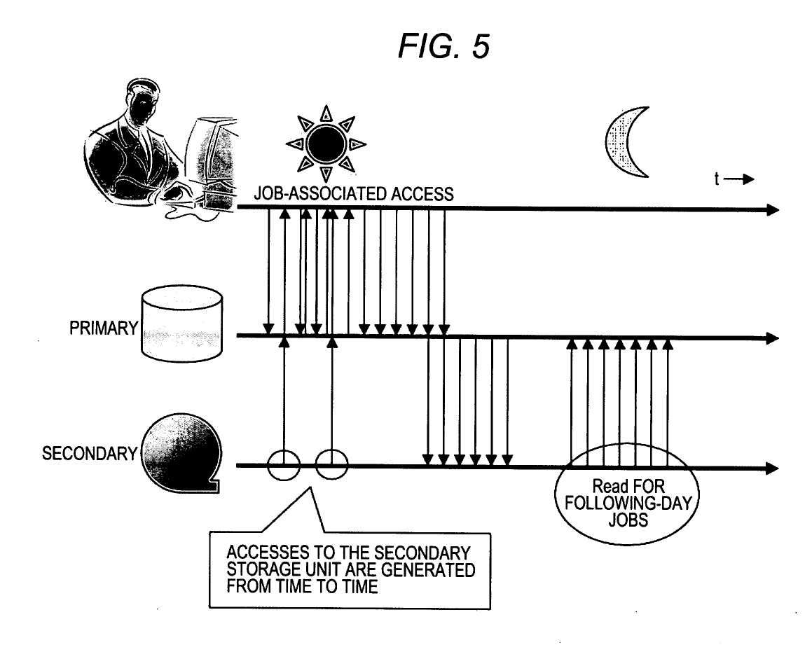

With reference to FIG. 5, depending on the case, requests for the secondary storage unit 3 can concentrate. In addition, depending on the case, a large number of garbage collection requests can be generated against the intention of the system administrator. As the frequency or number of the events of mounting/removing of the cartridge 38 is increased, the performance is degraded, and also wear of the cartridge 38 is accelerated. As such, according to the present embodiment, scheduling is performed to reduce the number of the events of mounting/removing the cartridge 38.

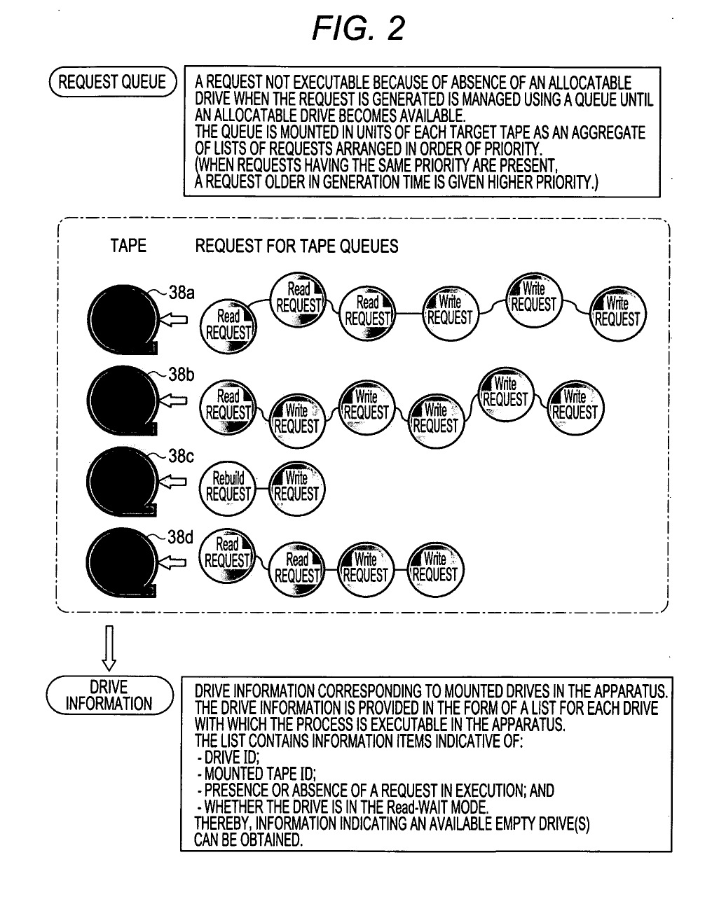

FIG. 2 is a diagram descriptive of request management information for managing request scheduling. The request management information are stored in areas allocated in the memory 45, and include queues and drive information.

The request is issued (generated) by necessity in units of the cartridge 38. Requests not executed (or processed) are managed using the queues allocated in the memory 45. As shown in FIG. 2, the queues are arranged in units of the cartridge 38 in order of the priority. In the case where requests having the same priority are present, an older request in generation time is given priority. The cartridges 38 themselves are managed in accordance with the IDs thereof.

The drive information is an aggregate of data indicative of the state of the tape drive 37 in units of the tape drive 37. The drive information of the tape drive 37 hereinbelow will be refer to as “drive ID” to distinguish from the ID information (“tape ID”, hereinbelow) of the cartridge 38. In units of the tape drive 37, the drive ID thereof includes the tape ID of a mounted cartridge 38, flag information indicative of presence or absence of a request in execution (process), and specification information indicative of whether the tape drive 37 is in a read-wait mode. The information makes it possible to identify whether the respective cartridge 38 is mounted on the respective tape drive 37, whether the respective tape drive 37 is empty, and whether the respective tape drive 37 is in a read-wait mode.

In the present embodiment, request scheduling is performed in accordance with the following rules:

(a) A request involving the use of a cartridge 38 once mounted on the tape drive 37 for execution of the request process is executed by priority for a fixed time period (prespecified time period (A minutes)); and/or

(b) A tape drive 37 used in continuous request execution is set as a read-wait drive exclusive drive (read request exclusive drive).

In accordance with the rule (a), a plurality of requests are grouped in units of the cartridge 38, and hence the plurality of requests are executed in series upon mounting of the target cartridge 38. Consequently, the number of the events of mounting/removing the cartridge 38 can be even more reduced, and hence the number of executable requests per unit time period can be even more increased. Time measurement is performed by using a hardware timer (not shown) built in, for example, the CPU 41.

The read request for the secondary storage unit 3 is generated when access cannot be made to data in the primary storage unit 2. While read requests are generated at random depending on the case, there also are many cases where read requests are generated when access is attempted to plural items of data (files). In this case, read requests for the specific cartridge 38 are generated in series.

The rule (b) is specified to enable scheduling to be implemented appropriately corresponding to the read request. In accordance with the rule (b), a cartridge 38 for which another request is either being generated or likely to be generated can be prevented from being removed from the tape drive 37 at a high probability. Thereby, the request can be executed even more efficiently, and further, reduction in the performance due to access to the secondary storage unit 3 can be minimized. Of the drive information, the specification information indicative of whether the drive is in the read-wait mode or not is indicated in accordance with the rule (b).

In order to perform scheduling meeting the rules (a) and (b), the system manages other items of the drive information in units of the tape drive 37. The items are mount time of a cartridge 38 currently being mounted, a history of an executed request, or time (execution time) at which a last request has been executed, or any combinations thereof. Thereby, the information management enables, for example, determination of whether the fixed time period has elapsed or not and referential access to executed requests. The history might be limited to only those for which scheduling can be performed in accordance with the rule (b). The execution time might refer to information for canceling the read-wait mode setting.

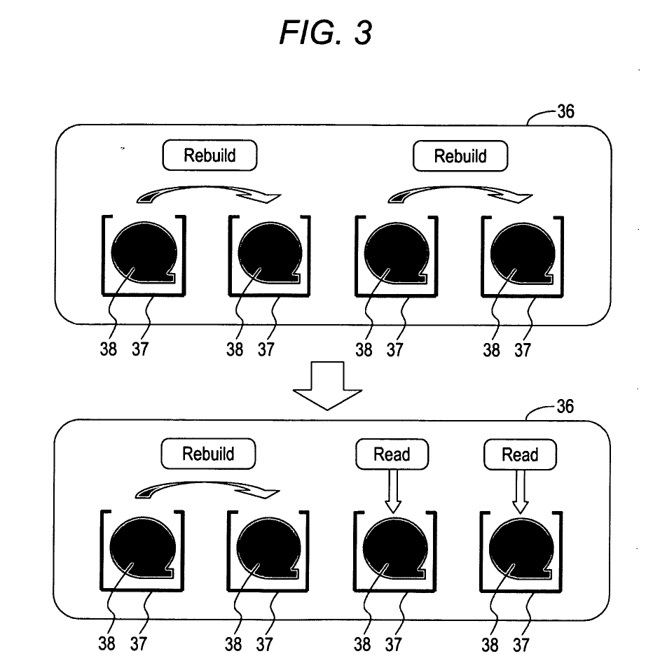

Requests for the secondary storage unit 3 are not only read requests, but also others, such as write and re-build requests. Taking this into account, an upper limit value is provided to limit the number of tape drives 37 settable to the read-wait mode so that the other requests can be executed. Thereby, as shown in FIG. 3, all the tape drives 37 are prevented from being in a state where the read request cannot be executed, thereby to enable another request to be executed on a tape drive 37 not set to the read-wait mode.

The upper limit value (maximum number of the tape drives) and the number of times (predetermined number of times) for a series of read requests for setting the read-wait mode are both alterable by the system administrator. This enables a proper response in accordance with the situation. Further, also the above-described fixed time and the like can be altered by the system administrator.

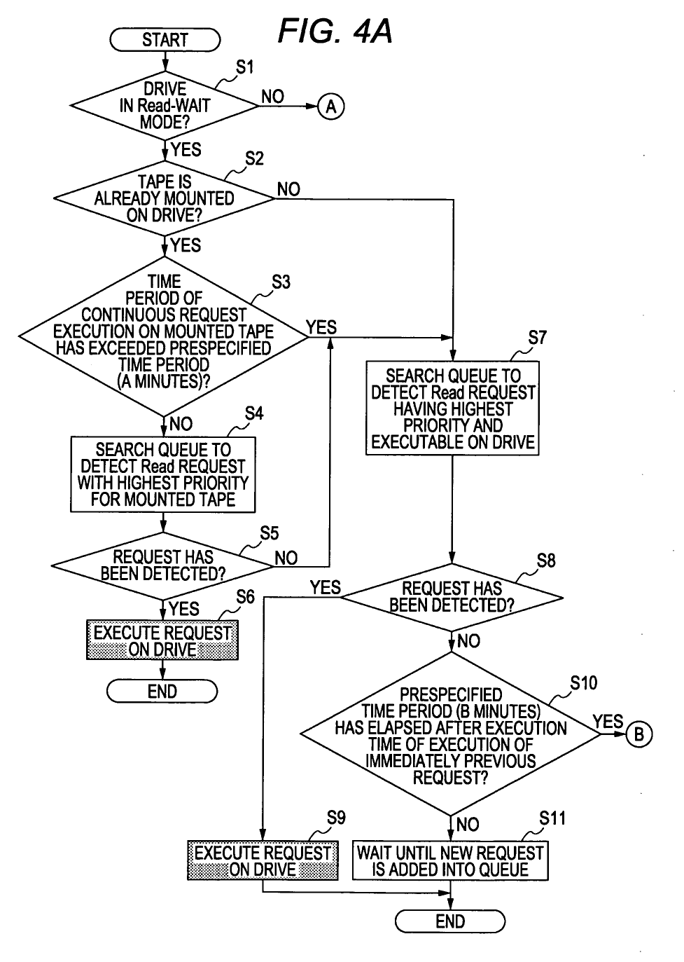

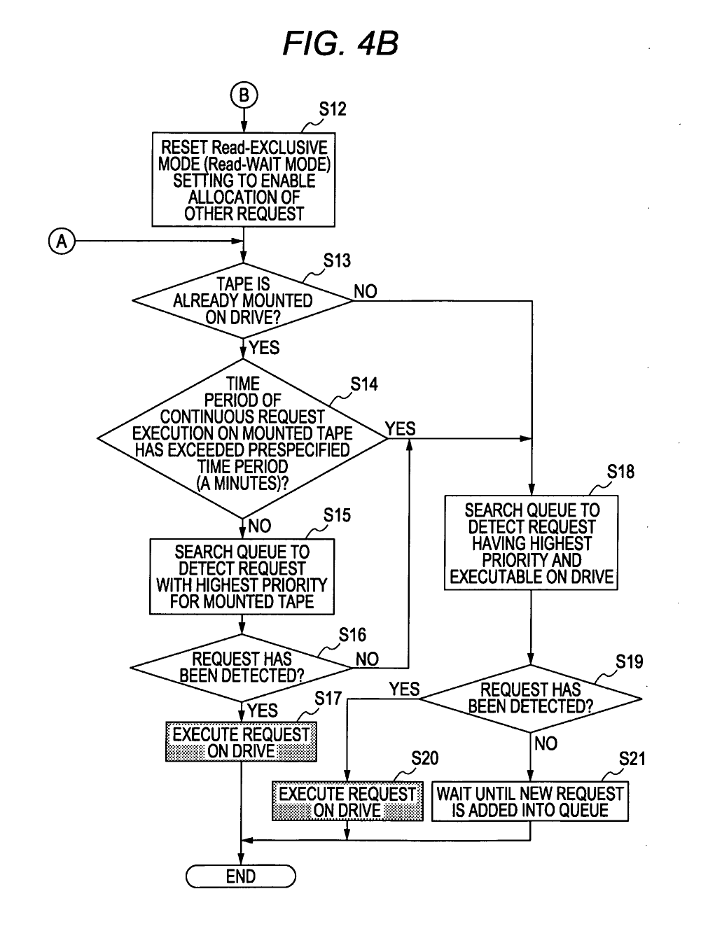

FIGS. 4A and 4B are flowcharts representing the scheduling process, according to an embodiment. The scheduling process is realized in the manner that the hierarchy control program is read out or invoked by the CPU 41 of the hierarchy controller 4 from the memory 45. The scheduling process is executed in units of each of the tape drive 37. The process is activated upon, for example, enqueueing of a new request into the request queue or termination of execution of the request. With reference to FIG. 4, processing or operation of the hierarchy controller 4 for realizing the scheduling process will be described in more detail herebelow.

First, at S1, it is determined whether a target tape drive 37 is in the read-wait mode or not. If no item of the drive information on the tape drive 37 is detected (determination result: “NO”), then the processing moves to S13. Otherwise, that is, if the tape drive 37 is set to the read-wait mode (determination result: “YES”), then the processing moves to S2.

At S2, it is determined whether a cartridge 38 (shown as “tape” in the flow chart) is already mounted on the tape drive 37 or not. If a cartridge 38 is not mounted thereon (determination result: “NO”), then the processing moves to S7. Otherwise, that is, if a cartridge 38 is already mounted (determination result: “YES”), then the processing moves to S3.

At S3, it is determined whether or not a time period of continuous request execution on the mounted cartridge 38 has exceeded the prespecified time period (A minutes). Normally, the time period is an elapsed time period after mounting of the cartridge 38. If the time period has not exceeded the prespecified time period (A minutes) (determination result: “YES”), then the processing moves to S7. Otherwise (determination result: “NO”), the processing moves to S4.

At S4, a search is performed in the queue to detect a read request with a highest priority from among requests issued on the mounted cartridge 38. At subsequent S5, it is determined whether the read request has been detected or not. If the read request has been detected (determination result: “YES”), then the processing moves to S6. At S6, the read request is executed; and after completion of the execution, the scheduling process terminates. Otherwise, that is, if the request has not been detected (determination result: “NO”), the processing moves to S7.

At S7, to which the processing moves when the determination results are “NO” at the respective S2 and S5 or the determination result is “YES” at S3, a process different depending on whether the processing has moved thereto as the “YES” determination result at S3 is executed.

In the event that the processing has moved to S7 as the “YES” determination result, there is a probability that the cartridge 38 is already mounted, and a read request for the cartridge 38 remains unexecuted. For this reason, in the event that the search is performed in the queue to detect the read request with the highest priority for the cartridge 38, but is not detected, a search is performed to detect a read request with a highest priority (corresponding to an oldest read request) from among read requests stored or enqueued in a queue corresponding to a cartridge 38 mountable on a corresponding tape drive 37. However, in the event that the processing has moved to S7 in other cases, it is already verified that either the cartridge 38 is not mounted or the targeted read request for the mounted cartridge 38 does not exist. As such, a read request with a highest priority is searched from among read requests stored in the queue for a cartridge 38 mountable on a corresponding tape drive 37. The search as described above is performed depending on the situation, and then the processing moves to S8.

At S8, it is determined whether or not the read request has been detected as a result of the search. If the read request has been detected (determination result: “YES”), then the processing moves to S9. At S9, the read request is executed in the tape drive 37, and then the scheduling process terminates. On the other hand, if the request has not been detected (determination result: “NO”), then the processing moves to S10.

At S10, it is determined whether or not a prespecified time period (B minutes) has elapsed after the execution time at which the execution of an immediately previous request was started and executed. If the prespecified time period (B minutes) has elapsed (determination result: “YES”), then the processing moves to S12 at which the read-wait mode setting is cancelled or reset to thereby allow another request to be specifiable. Otherwise (determination result: “NO”), the processing moves to S11 to wait an event where a new request is added or enqueued into the queue. The read-wait mode is performed by rewriting specification information indicative of whether the tape drive 37 is in the read-wait mode.

Thus, according to the present embodiment, the specification for the read-wait mode is reset in accordance with the condition of the elapse of the prespecified time period (B minutes) after the initiation of execution of the last request. In the read-wait mode having been set, only the read request is executed. Thereby, read requests generated in series are addressable. The read-wait mode can be set or reset by rewriting of the specification information on the corresponding tape drive 37 among the drive information (see FIG. 2).

In the event that the determination result at S2 is “NO”, the processing moves to S13. At S13 to S20, similar processes to those in S2 to S9 are executed. One difference in the processes is that targets of the search or execution in S2 to S9 are limited to read requests and S13 to S20 can be any requests. As such, descriptions of S13 to S20 are omitted herefrom. At S21 to which the processing has moved in accordance with a “NO” determination result at S19, similarly as at S11, the processing determines to wait an event where a new request is added or enqueued into the queue, and then the scheduling process terminates.

Mounting of a cartridge 38, which has not yet been mounted, is performed at either S9 or S20. Although not specifically shown, the mounting time for measuring the elapsed time period in comparison with the prespecified time period (A minutes) is rewritten in the event that the replacement (events of mounting/removing) of the cartridge 38 is specified for request processing during execution of S9 or S20. Thereby, the elapsed time period can be specified in accordance with the difference from the present time. In this event, the processing concurrently executes rewriting of, for example, the tape ID, flag information indicative of the presence or absence of a request in execution (process), and execution time, and storing of the history of the executed request. In the secondary storage unit 3, the robot 33 is activated by the controller 34 to thereby mount a to-be-mounted cartridge 38 to a corresponding tape drive 37. Rewriting of flag information and execution time and storing of an executed request are similarly executed also in S6 and S17.

As described above, the read-wait mode is set specified in the event that read requests for the same cartridge 38 are executed a predetermined number of times or more in series. Accordingly, the read-wait mode is set in the event that S17 is executed ((predetermined number of times)−1) times in series on the same tape drive 37. In order to prevent the number of times from exceeding the value of the upper limit, when a tape drive 37 already having reached the value of the upper limit is set to the read-wait mode, the read-wait mode setting is not newly set. Alternatively, when newly setting the read-wait mode, the read-wait mode setting of, for example, either a tape drive 37 most previously set to the read-wait mode or empty tape drive 37 is reset. Since the read-wait mode setting of such a tape drive 37 is reset, a tape drive 37 having an even higher probability of receiving a series of read requests can be set by priority to the tape drive 37.

In the present embodiment, although the tape library 3 is employed as the secondary storage unit 3, a different type of storage may be employed. For example, the secondary storage unit 3 may be configured from storage of the type in which optical disks, such as DVDs, are replaceable. Further, request scheduling such as described above may be performed for a tertiary or higher order storage unit.

The embodiments can be implemented in computing hardware and/or software. The described operations/features can be provided in any combination. The request scheduling apparatus of the present embodiment is realized in the hierarchy controller 4 (computer) in the manner that the hierarchy control program is installed in the hierarchy controller 4. However, instead of being mounted in the apparatus such as the hierarchy controller 4, the request scheduling apparatus may be a different type of an apparatus (computer) used as the host 1 or the like. The hierarchy control program need not be of the type that is preliminarily stored in the memory 45, but may be of the type that can be installed by being stored into any computer readable recording media, such as an optical disk, flash memory, or the like. Still alternatively, the hierarchy control program may be of the type distributable through the communications network. As such, the hierarchy control program, such as described above, which is capable of performing request scheduling, may be of the type stored in a computer readable recording medium accessible by an apparatus connected to the communications network.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method of scheduling one or more request for a secondary storage unit in a hierarchical storage management system that includes a plurality of drive units and that controls a storage unit as the secondary storage unit, the storage unit permitting recording media to be removably mounted on the respective drive units, the method comprising:
searching for one or more request(s) processed, in process or to be executed as executable, or any combinations thereof, on a drive unit, in units of the drive unit; and
in accordance with the searching detecting one or more generated read request(s) to read data from a recording medium mounted on the drive unit, and setting the drive unit as an exclusive drive for the read request(s).

2. A request scheduling method according to claim 1, wherein the setting of the exclusive drive unit is based upon the drive unit having processed a predetermined number of the read requests in series.

3. A request scheduling method according to claim 1, wherein the setting of the exclusive drive unit is based upon limiting a number of the drive units settable to the read-wait mode to a predetermined upper limit value.

4. A request scheduling method according to claim 1, further comprising:
measuring an elapsed time period in units of the drive units after a recording medium has been mounted on a drive unit to execute request(s); and
scheduling based upon the measuring a drive unit with an elapsed time period not exceeding a predetermined time period to execute an executable request by priority.

5. A method of scheduling one or more request(s) for a secondary storage unit in a hierarchical storage management system that includes a plurality of drive units and that controls a storage unit as the secondary storage unit, the storage unit permitting recording media to be removably mounted on the respective drive units, the method comprising:
measuring an elapsed time period in units of the drive units after a recording medium has been mounted on a drive unit to execute request(s); and
based upon the measuring scheduling a drive unit having an elapsed time period not exceeding a predetermined time period to execute an executable request by priority.

6. A request scheduling apparatus performing scheduling of one or more request(s) for a secondary storage unit in a hierarchical storage management system that includes a plurality of drive units and that controls a storage unit as the secondary storage unit, the storage unit permitting recording media to be removably mounted on the respective drive units, the apparatus comprising:
a controller
searching for one or more request(s) processed, in process or to be executed as executable, or any combinations thereof on a drive unit, in units of the drive unit,
according to the searching detecting one or more generated read request(s) to read data from a recording medium mounted on the drive unit, and
setting the drive unit as an exclusive drive for the read request(s).

7. A request scheduling apparatus performing scheduling of one or more request(s) for a secondary storage unit in a hierarchical storage management system that includes a plurality of drive units and that controls a storage unit as the secondary storage unit, the storage unit permitting recording media to be removably mounted on the respective drive units, the apparatus comprising:
a controller
measuring an elapsed time period in units of the drive units after a recording medium has been mounted on a drive unit to execute request(s); and
based upon the measuring scheduling a drive unit having an elapsed time period not exceeding a predetermined time period to execute an executable request by priority.

8. A computer readable recording medium storing a request scheduling program for controlling a computer to schedule one or more request(s) for a secondary storage unit in a hierarchical storage management system that includes a plurality of drive units and that controls a storage unit as the secondary storage unit, the storage unit permitting recording media to be removably mounted on the respective drive units, according to operations comprising:
searching for one or more request(s) processed, in process or to be executed as executable, or any combinations thereof on a drive unit, in units of the drive unit,
according to the searching detecting one or more generated read request(s) to read data from a recording medium mounted on the drive unit, and
setting the drive unit as an exclusive drive for the read request(s).

9. A computer readable recording medium storing a request scheduling program for controlling a computer to schedule one or more request(s) for a secondary storage unit in a hierarchical storage management system that includes a plurality of drive units and that controls a storage unit as the secondary storage unit, the storage unit permitting recording media to be removably mounted on the respective drive units, according to operations comprising:
measuring an elapsed time period in units of the drive units after a recording medium has been mounted on a drive unit to execute request(s); and
based upon the measuring scheduling a drive unit having an elapsed time period not exceeding a predetermined time period to execute an executable request by priority.

10. The method according to claim 1, further comprising queuing executable requests on a target removable recording media basis, and the searching search the queue for one or more executable requests for the target removable recording media.
